(19) United States
(12) Patent Application Publication
(10) Pub. No.: US 2002/0072984 A1
(43) Pub. Date: Jun. 13, 2002

(54) Method and apparatus for the distribution and sale of a branded product

(76) Inventors: Glenn Rothman, Wellesley Hills, MA (US); Avner Arazi, Boston, MA (US)

Correspondence Address: MORGAN & FINNEGAN, L.L.P., 345 Park Avenue, New York, NY, 10154, US

(21) Appl. No.: 09/736,471

(22) Filed: Dec. 13, 2000

Related U.S. Application Data
(60) Provisional application No. 60/208,521, filed on Jun. 1, 2000.

(51) Int. Cl. G06F 17/60

(52) U.S. Cl. 705/26

(57) ABSTRACT

A system and method of the present invention allows a seller of a branded product, such as a diamond seller, to attract both buyers and retailers using a web site on the Internet. Buyers may register with the web site by providing personal identification information including a financial account identifier. Buyers may then receive information on a branded product and order the product online. If the product is ordered, it may be retrieved by the user at an independent or franchised retailer corresponding to the geographic location of the buyer or shipped to the buyer by that retailer. Such local retailers, as well as individual employees of the same, may register with the seller to sell the product. The local retailers may then provide inventory information and receive appropriate orders received through the seller's web site. The local retailers and individual employees may receive compensation from the seller for sales of the product. Local retails may furthermore be rated based on sales of the product and may receive further compensation based on their rating and/or further criteria. Existing online commerce methods, such as banner advertising, may also be combined with the methods of the present invention.

### CROSS-REFERENCE TO RELATED APPLICATIONS

This application claims priority under 35 U.S.C. §119 to U.S. Provisional Patent Application Serial No. 60/208,521 entitled “METHOD AND APPARATUS FOR THE DISTRIBUTION AND SALE OF A BRANDED PRODUCT” filed in the name of Glenn Rothman on Jun. 1, 2000, the entirety of which is incorporated herein by reference.

### FIELD OF THE INVENTION

The present application relates generally to data processing for financial transactions and relates more specifically to a system for selling, promoting and distributing a product online.

### BACKGROUND OF THE INVENTION

Many methods exist for conducting business online. In typical configurations, one or more computer servers are operative to provide information to users over a computer network, such as by providing a web site on the World Wide Web. A number of users may simultaneously access the servers via remote computer terminals which connect to the computer servers over a telecommunications connection. The information provided by the operator of the web site may include products which are available for sale to a user. The user may provide financial account information, such as a credit card number, to purchase the available products. The operator may then charge the financial account for the purchase.

The operator may gain further revenues by posting banner advertisements from third parties which are visible on the web site. Typically, the operator is compensated based on the number of users who access the web site or view the advertisement.

However, few methods have been proposed for promoting products through an independent and/or franchised network of distributors using the Internet. Such methods may allow a seller to harness the Internet to promote a product to both buyers and potential distributors of the product. Sellers of branded products, such as diamond sellers, may benefit from an online embodiment of such a system due to the difficulty of establishing, encouraging and maintaining committed distributors for their product through traditional channels.

Accordingly, a method and apparatus for the distribution and sale of a branded product is proposed herein to address certain shortcomings of existing technologies.

### SUMMARY OF THE INVENTION

A first embodiment of the present invention provides a method and apparatus for selling a product online. According to this embodiment, a seller server stores registration information for any number of retailers. A product order is received from a customer in a geographical location. The seller server than identifies one or more retailers in the geographic location having an available product.

According to a second embodiment of the present invention, a method and apparatus is provided to identifying a geographic location of a user accessing ordering a product online. In this second embodiment, an internet protocol address of a user's computer is determined by a seller server. The seller server, in turn, accesses an internet provider database storing the internet protocol address and retrieves a geographic location of the user from the internet provider database.

In a third embodiment of the present invention, a method and apparatus is provided for registering a retailer, in order to accomplish an online sale of a product. According to this embodiment, a seller server receives a selection of a territory from a retailer corresponding to a geographic location for which the retailer is responsible for a product sale, The seller server further receives, from the retailer, an inventory of available products and a price at which at least one of the available products is to be sold.

According to a fourth embodiment of the present invention, a method and apparatus is provided for registering with a seller to accomplish an online sale of a product. In this embodiment, a retailer transmits to a seller a selection of a territory corresponding to a geographic location for which a retailer is responsible for a product sale. The retailer further transmits an inventory of available products and a price at which at least one of the available products is to be sold.

### BRIEF DESCRIPTION OF THE DRAWINGS

Further aspects of the instant invention will be more readily appreciated upon review of the detailed description of the preferred embodiments included below when taken in conjunction with the accompanying drawings, of which:

FIG. 1 is a schematic block diagram illustrating an exemplary computer network according to an embodiment of the present invention,

FIG. 2 is a schematic block diagram of exemplary components of a seller's central server according to an embodiment of the present invention,

FIG. 3 is a representation of an exemplary user database stored by the central server of FIG. 2;)

FIG. 4 is a representation of an exemplary local distributor database stored by the central server of FIG. 2;

FIG. 5 is a representation of an exemplary inventory database stored by the central server of FIG. 1

FIG. 6 is a representation of an exemplary transaction database stored by the central server of FIG. 2;)

FIG. 7 is a flow chart depicting an exemplary buyer registration process according to an embodiment of the present invention,

FIG. 8 is a flow chart depicting an exemplary local distributor registration process according to an embodiment of the present invention,

FIG. 9 is a flow chart depicting an exemplary transaction process according to an embodiment of the present invention;

FIG. 10 is an exemplary audit and compensation process according to an embodiment of the present invention;

FIG. 11 is a flow chart depicting an exemplary buyer location process,

FIG. 12 is an exemplary screen display of a home page for a web site maintained by the server of FIG. 2;

FIG. 13 is an exemplary screen display for receiving buyer location data according to one embodiment of the present invention;

FIG. 14 is an exemplary screen display for receiving desired product descriptions from a buyer;

FIG. 15 is an exemplary screen display of product search results for a search entered by the buyer,

FIG. 16 is an exemplary screen display of a product inscription order form according to an embodiment of the present invention;

FIG. 17 is an exemplary online order form according to one embodiment of the present invention;

FIGS. 18-21 are exemplary screen displays for an online insurance application form according to an embodiment of the present invention;

FIG. 22 is an exemplary screen display of a online financing application form according to an embodiment of the present invention;

FIG. 23 is an exemplary screen display for allowing a buyer to receive product information and to submit questions to experts according to an embodiment of the present invention;

FIG. 24 is an exemplary screen display for a virtual postcard order according to an embodiment of the present invention,

FIG. 25 is an exemplary screen display of a retailer inventory listing according to an embodiment of the present invention;

FIG. 26 is an exemplary screen display of a retailer markup selection form according to an embodiment of the present invention; and

FIG. 27 is an exemplary screen display of an online retailer audit form according to an embodiment of the present invention.

### DETAILED DESCRIPTION OF THE PREFERRED EMBODIMENTS

According to certain embodiments of the present invention as described herein, a method and accompanying apparatus for selling and distributing a product online includes providing a network site on a computer network which may be accessible to a plurality of users and a plurality of retailers or local independent distributors. The network site may be a web site operated by a seller which provides product information on one or more products, such as diamonds, and through which such products may be sold.

A user accessing the network site may register with the operator of the site by providing personal identification information, which preferably includes a geographic location, e.g. a zip code or a telephone area code, of the user and a financial account identifier, such as a credit card number, from which the user may authorize the withdrawal of funds to accomplish a purchase. In the alternative, the geographic location of the user may be determined based on a unique computer address stored by the user's remote terminal. The user information may be used to generate an icon representation of the user on the web site, the icon corresponding to the demographic of the user as determined from the identification information. The user information may then be stored in a user database maintained by the network server.

Either before or after a user registration process has been completed, the user may view product information provided by the network site. Such information may include audio, visual, and/or audio visual messages and depictions which convey product information, such as product quality, available sizes, available configurations, and methods of delivery of the product. The operator of the web site may also provide a forum hosted by an expert, through which users may submit questions regarding the product to the experts, and receive answers to the same, on a 24-hour basis.

A user may then order the product through the web site. The user may preferably specify an online purchase or an offline purchase of the product. Upon receipt of an online purchase order, the network server may communicate with a third party payment processing server, such as those operated by online credit card clearinghouses, to accomplish a payment for the sale. The operator of the network server may then ship the product to the user at an address specified by the user.

Upon receipt of an offline purchase request, the user may be directed to one or more retailers who sell the product in the same geographic region as the user. The user may then pick up the product at the local distributors location, and may further pay for the product at the location. Both online and offline purchase transaction data may then be stored in a transaction database maintained by the network central server.

In particular embodiments, the user may order customized products by specifying an inscription to be placed on the product. Such inscriptions may include laser inscription by which miniaturized messages may be placed on the product. The messages may be personal messages entered by the user or may be a selection of a predetermined message suggested by the seller via the network site. In additional embodiments, the user may purchase insurance for the product through the web site.

In further embodiments of the present invention, a plurality of local retailers (also referred to herein as distributors) may register with the web site in order to sell the product offered by the seller at one or more geographical locations. The local distributors may be independent or franchised retailers having a known, geographic location. During the local distributor registration process, a local distributor preferably provides identification information including the geographic location of a retail store operated by the local distributor and employee information including the names of employees responsible for sales of the product. This distributor registration information may then be stored in a distributor database maintained by the central server.

The local distributor may then select or be assigned a geographic region in which the distributor is responsible for sales of the product. In a case where the geographic region is assigned by the seller, the geographic region may correspond to the geographic location of the retailer. In a case where the retailer selects a geographic region, the retailer may select any one or more regions in which it is responsible for sales of the product. The retailer may pay for rights to the region, including the right to designate the region as exclusive to the retailer. The price a retailer pays for each region may be separately negotiated with the seller operating the web site.

The seller's product, as well as competing products, may be sold at the independent retailer's location. Accordingly, in order to encourage retailers to sell the product, several incentives are provided. First, the retailer may be allowed to set a price for the product in the retailer's territory. If more than one retailer is in a given territory, each may be given access to the portion of the transaction database which stores sales data for that region. The transaction database may then be audited by each retailer to determine the level of sales in the region and determine their price accordingly.

Next, the sales accomplished by the local retailer are tracked by the seller. The seller may then compensate the local distributor based on the level of sales completed. Such compensation may include any or all of the following: monetary payments, a commission, a bonus, and an ownership interest in the seller's corporation. Individual employees of the local distributor may also be compensated for accomplishing particular sales levels. Such sale levels may be based on a number of products sold, a value of products sold, and or a ranking of the distributor/employee compared to other distributors and employees participating with the seller.

In a further embodiment, the local distributors may store inventory information on the central server by which users may determine what types of products are available at the local retailer. The inventory information may further be used by the seller to determine, for example, if the distributor is maintaining minimum required amounts of the product in its stock.

In another embodiment of the invention, a user may return a product ordered online to a local distributor identified by the web site as being in the same geographic region as the user, even if the local distributor did not participate in the sale of the product. The product may then be returned to the seller or maintained by the local distributor for re-sale. If the product is returned to the seller, the local distributor is compensated for the refund it provided to the user.

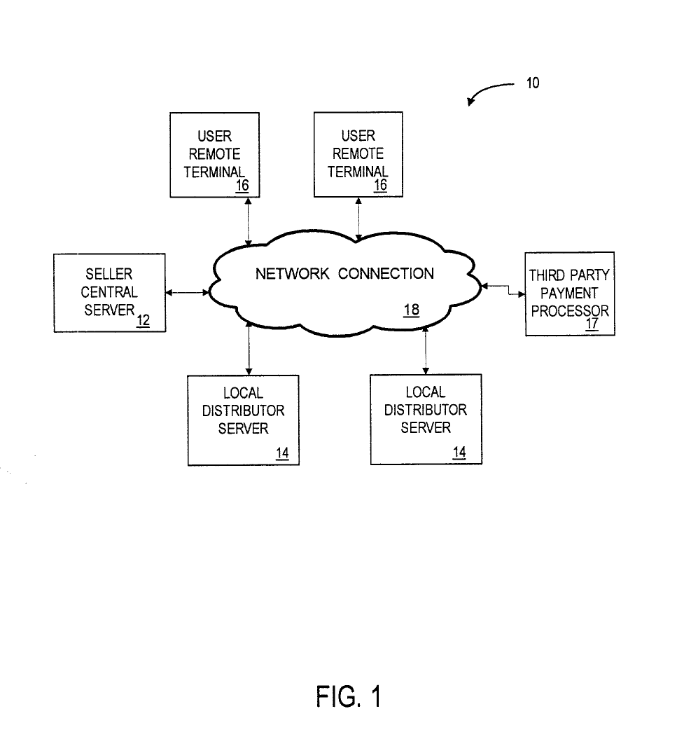

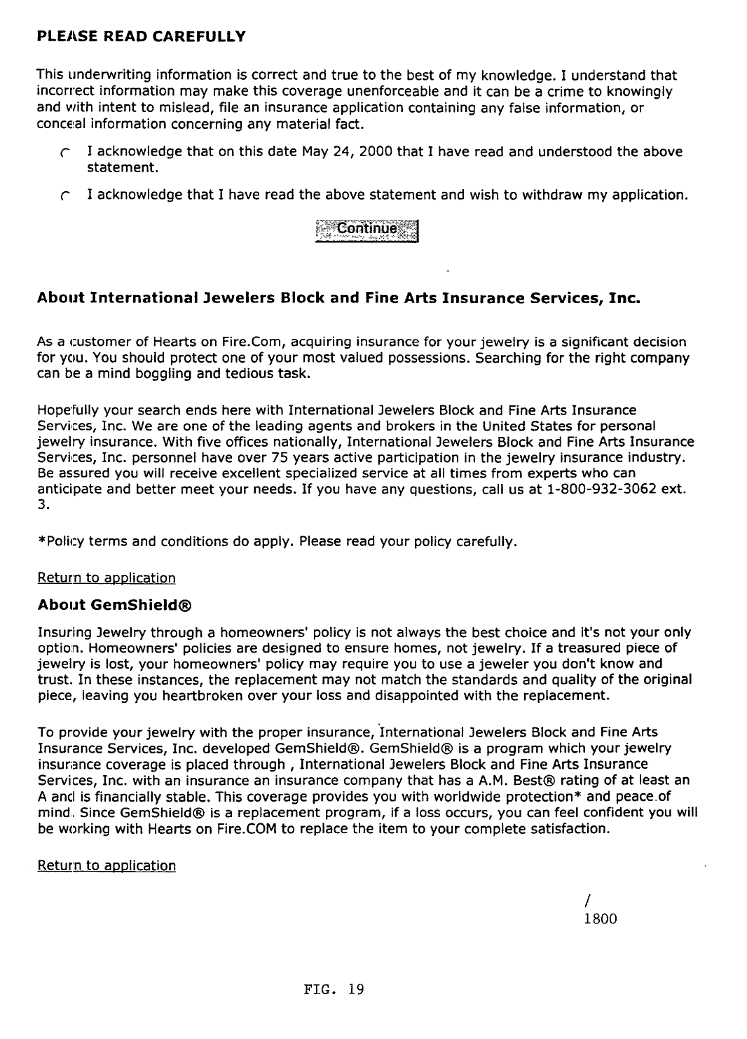

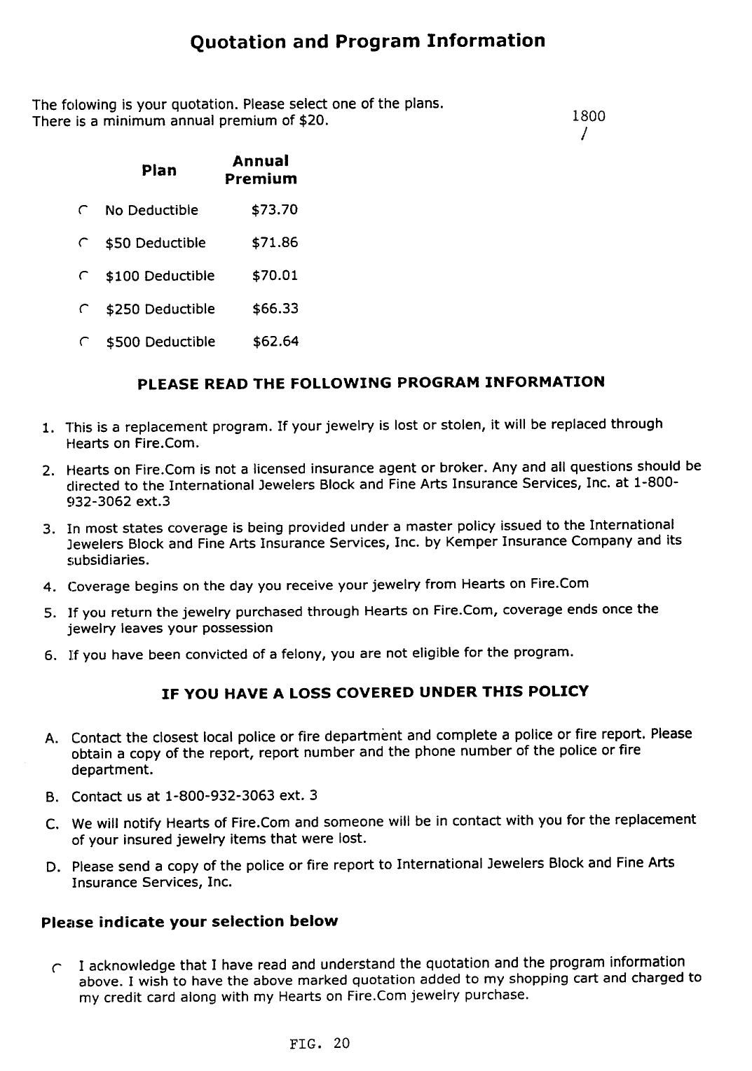

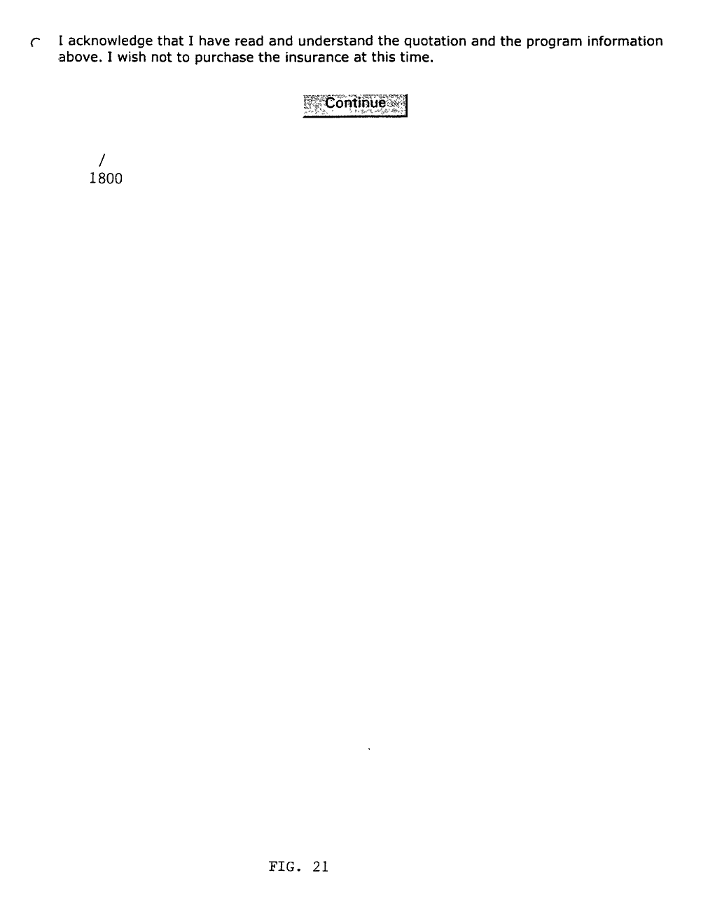

Referring now to FIGS. 1-27, wherein similar components of the present invention are referenced in like manner, preferred embodiments of a method and system for selling and distributing a product online are disclosed.

Turning now to FIG. 1, there is depicted an exemplary computer network 10 through which a plurality of users operating remote user terminals 16 may communicate with one or more seller central servers 12 over a network connection 18 in order to receive product information and to submit product orders. Local distributor servers 14 and third party payment processing servers 17 may also be disposed in communication with the seller's central server 12 through the network connection 18. Although the Computer network shown is preferably an Internet-based network such as the World Wide Web, it may be any one or more of a local area network (LAN), a wide-area network (WAN), an intranet environment, an extranet environment, a wireless network or any other type of computer network such as those enabled over public switched telephone networks.

The user terminals 16 may each be any type of computing device, such as a personal computer, a workstation, a network terminal, a hand-held remote access device, a personal digital assistant (PDA) or any other device that can accomplish two-way electronic communication over the network connection 18. Specific functions and operations of user terminals 16, the central servers 12, third party payment processor 17 and local distributor servers 14 are discussed further below.

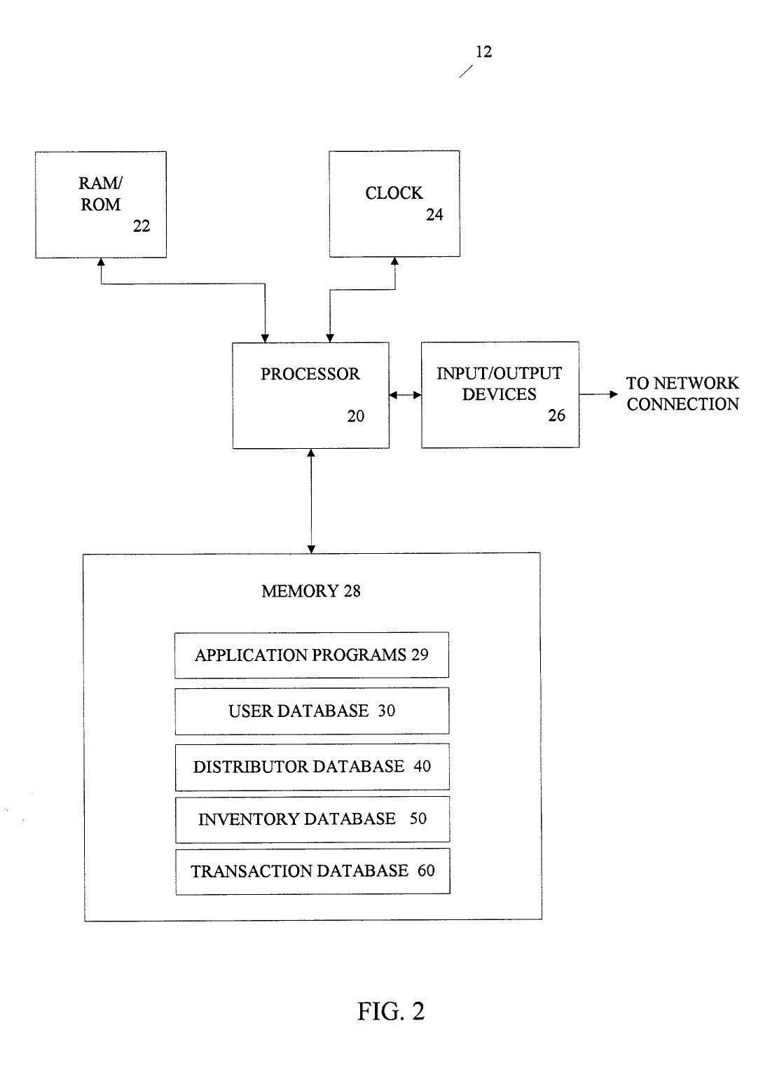

Turning now to FIG. 2, displayed therein are exemplary components of a computing device, such as a seller's central server 12. It should be understood that any of user terminals 16, local distributor servers 14 and third party payment processing servers 17 may share similar configurations. However, for sake of brevity, the discussion immediately below will refer to the seller's central server 12 only.

The primary component of the central server 12 is a processor 20, which may be any commonly available microprocessor, such as the PENTIUM III manufactured by INTEL CORP. The processor 20 may be operatively connected to further exemplary components, such as RAM/ROM 22, a clock 24, input/output devices 26, and a memory 28 which, in turn, stores one or more computer application programs 29, a user database 30, a local distributor database 40, an inventory database 50 and a transaction database 60.

The processor 20 operates in conjunction with random access memory and read-only memory in a manner well known in the art. The random-access memory (RAM) portion of RAM/ROM 22 may be a suitable number of Single In-line Memory Module (SIMM) chips having a storage capacity (typically measured in kilobytes or megabytes) sufficient to store and transfer, inter alia, processing instructions utilized by the processor 20 which may be received from the application programs 29. The read-only memory (ROM) portion of RAM/ROM 22 may be any permanent, non-rewritable memory medium capable of storing and transferring, inter alia, processing instructions performed by the processor during a start-up routine of the central server.

The clock 24 may be an on-board component of the processor 20 which dictates a clock speed (typically measured in MHz) at which the processor 20 performs and synchronizes, inter alia, communication between the internal components of the central server 12.

The input/output device(s) 26 may be one or more commonly known devices used for receiving operator inputs, network data, and the like and transmitting outputs resulting therefrom. Accordingly, exemplary input devices 26 may include a keyboard, a mouse, a voice recognition unit and the like for receiving operator inputs.

Output devices 26 may include any commonly known devices used to present data to an operator of the central server 12 or to transmit data over the computer network 10 to remote user terminals 16 and the local distributor servers 14. Accordingly, suitable output devices 26 may include a display, a printer and a voice synthesizer connected to a speaker. Other input/output devices 26 may include a telephonic or network connection device, such as a telephone modem, a cable modem, a T-1, T-2 or T-3 connection, a digital subscriber line or a network card, for communicating data to and from other computer devices over the computer network 10. In an embodiment involving a network server, it is preferred that the communications devices used as input/output devices 26 have the capacity to handle high bandwidth traffic in order to accommodate communications with a large number of user terminals 16 and local distributor servers 14.

The memory 28 may be an internal or external large capacity device for storing computer processing instructions, computer-readable data, and the like. The storage capacity of the memory 28 is typically measured in megabytes or gigabytes. Accordingly, the memory 28 may be one or more of the following: a floppy disk in conjunction with a floppy disk drive, a hard disk drive, a CD-ROM disk and reader/writer, a DVD disk and reader/writer, a ZIP disk and a ZIP drive of the type manufactured by IOMEGA CORP., and/or any other computer readable medium that may be encoded with processing instructions in a read-only or read-write format. Further functions of and available devices for memory 28 will be apparent.

The memory 28 preferably stores, inter alia, a plurality of application programs 29 which may be include an operating system such as WINDOWS 2000 by MICROSOFT CORP, and one or more application programs, such as a web hosting program and a database management program, each of which may be necessary to implement the embodiments of the present invention. The programs 29 preferably include processing instructions for accomplishing communication of data between the user terminals 16, the central server 12, the third party payment processor 17 and the local distributor servers 14, as described herein. Accordingly, the web hosting software may include functionality sufficient to read JAVASCRIPT, HTML, XML and other similar computer-oriented programming languages typically used in conjunction with Internet applications. The programs preferably also include a database management program of the type commonly manufactured by ORACLE CORP. in order to save, retrieve and analyze user identification data, local distributor identification data and transaction information received through the central server 12. The programs 29 also preferably include other applications, such as VISUAL BASIC, to allow an operator to program specific functions to be performed by the central server 12 as described herein. The programs operate to form a functional commercial web site which operates in the manner described hereinbelow.

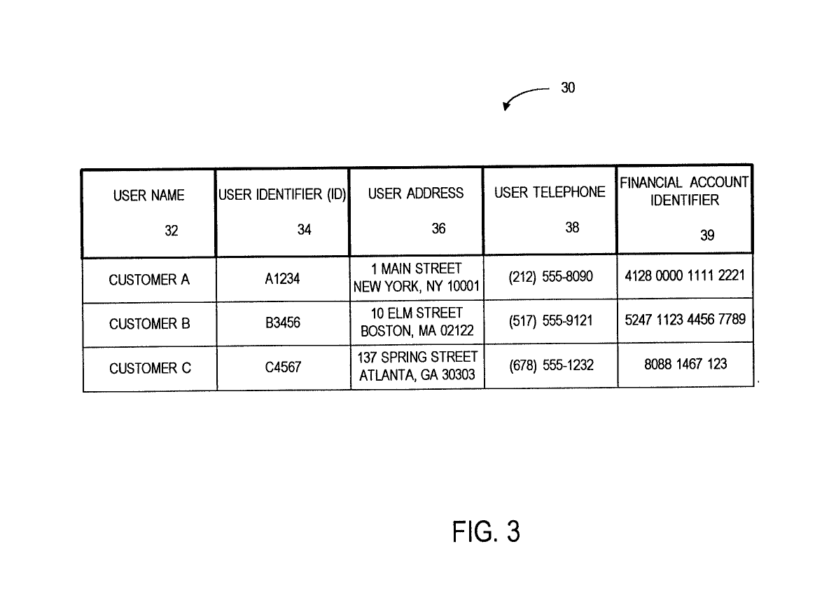

The memory 28 preferably also stores a plurality of relational databases, such as a user database 30, a local distributor database 40, an inventory database 50 and a transaction database 60, examples of which are depicted in FIGS. 3-6 respectively below. In referring to the databases depicted therein, it is important to note that the first row of the databases includes a field header for each field of the database and the remaining rows each correspond to one record of the database. Fields of data, are represented by each column. Further or fewer fields and records of data may be used. The databases presented herein may be configured into any number of relational databases. In addition, configurations other than database formats may be used to store the data maintained in the exemplary databases.

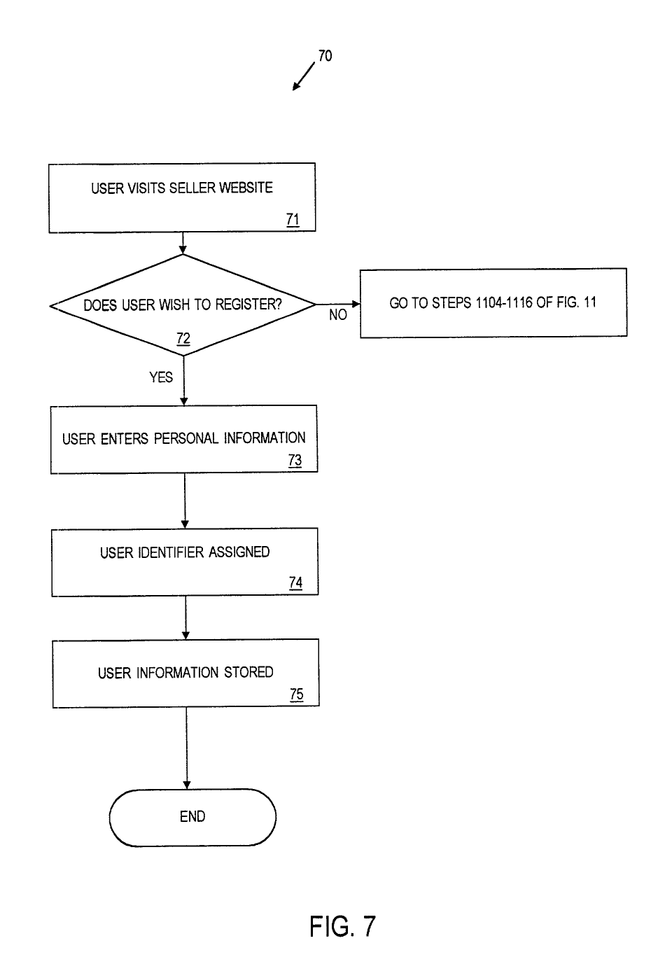

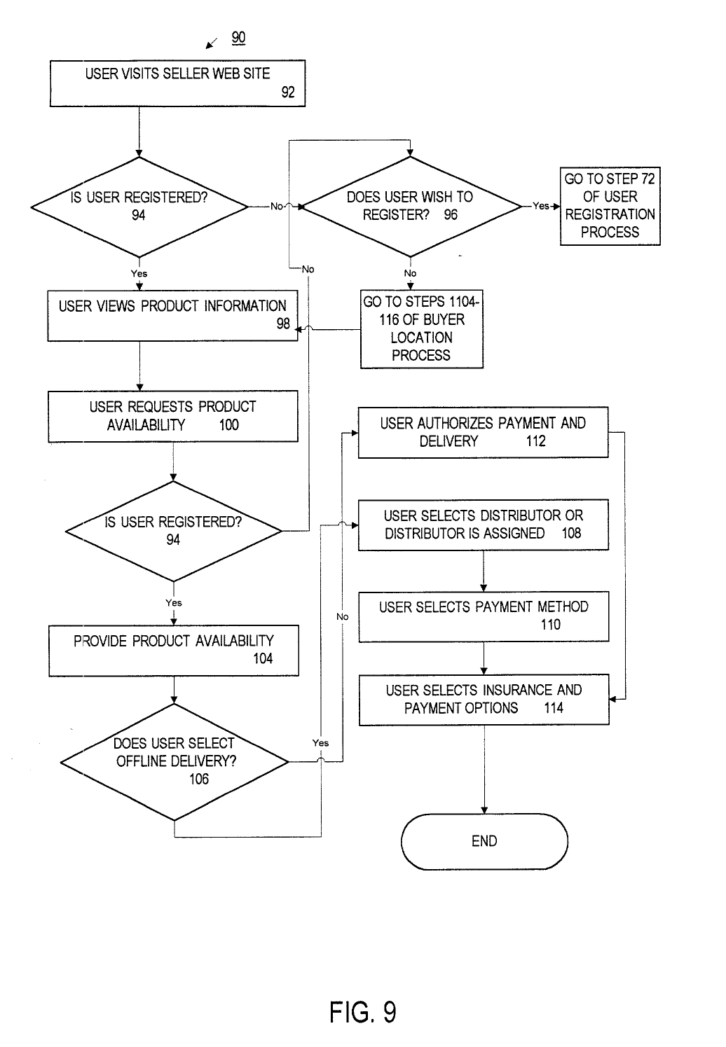

Referring now to FIG. 3, an exemplary user database 30 is provided to store and maintain user identification data provided by a user accessing a web site operated by the seller The data is received and stored according to the user registration process 70 as described below with respect to FIG. 7. The data may further be used in the transaction process 90 described with respect to FIG. 9 below. Accordingly, the user database 30 preferably includes a user name field 32 for storing the name of the user, a user identifier field 34 for storing an identifier assigned to the user, a user address field 36 for storing the geographic location of the user, a user telephone field 38 for storing the user's telephone number and a financial account identifier field 39 for storing a financial account maintained by the user. The financial account is preferably a credit card account or other suitable accounts through which charges may be applied online by the seller against the account, and may further be processed by the third party payment processing server 17 depicted in FIG. 1.

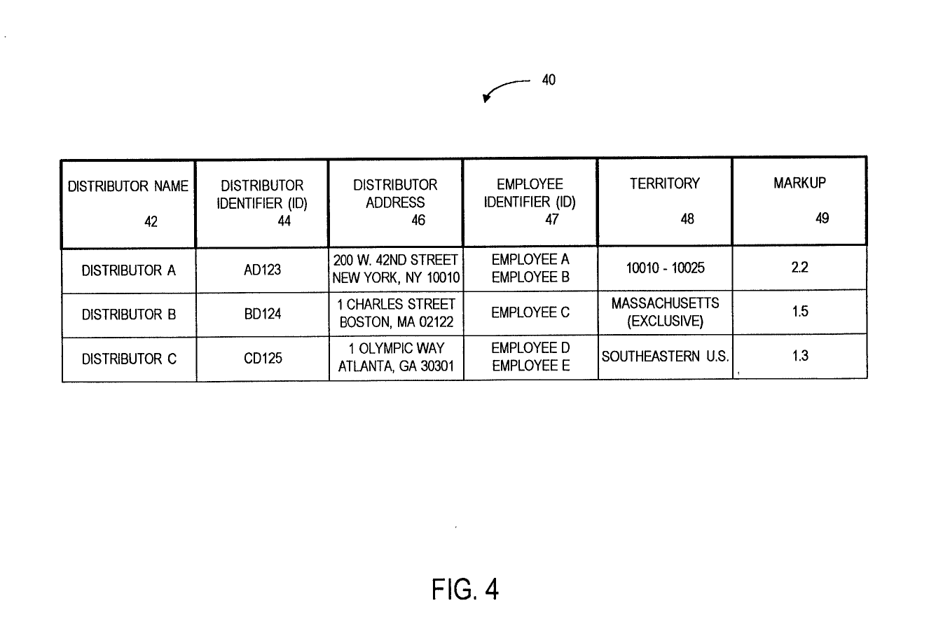

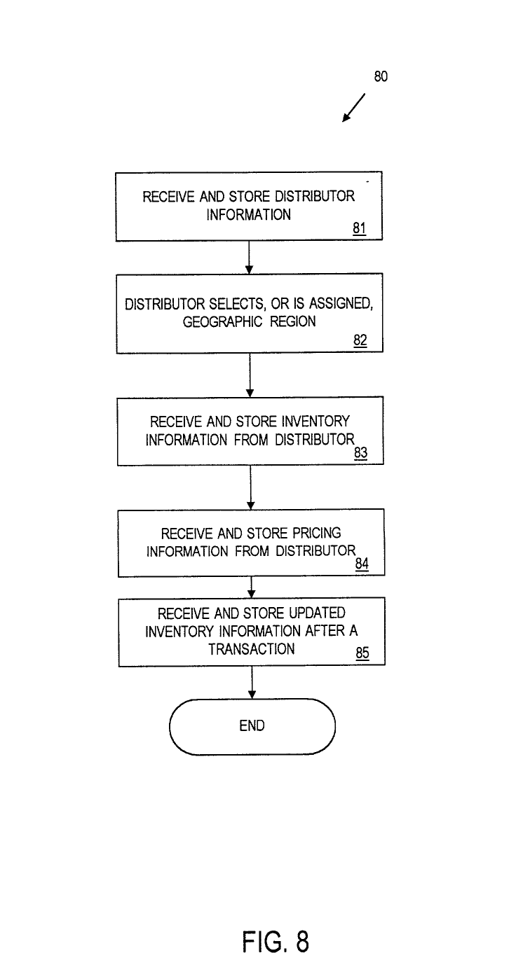

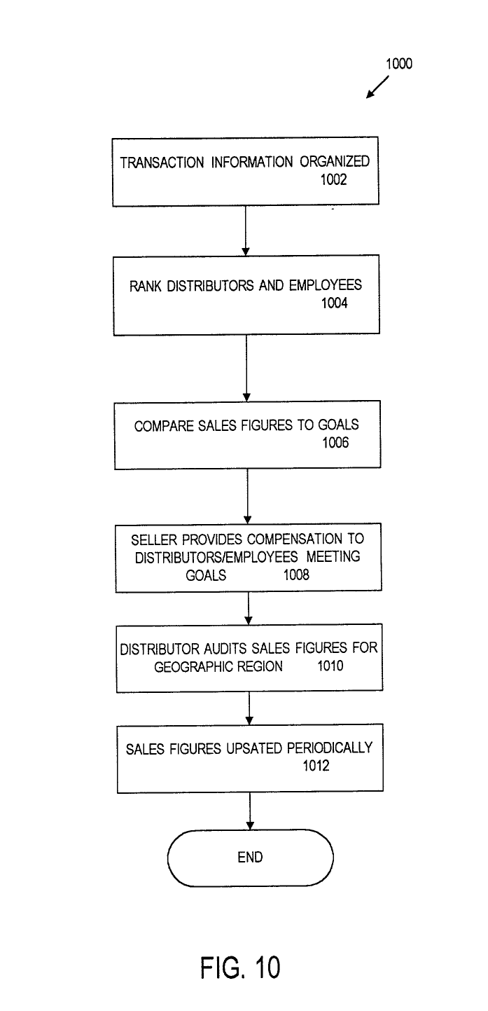

Turning now to FIG. 4, there is depicted an exemplary distributor database 40 which preferably stores registration information provided by local distributors wishing to participate in the sale of the product offered by the seller. The data is entered according to the distributor registration process 80 as described below with respect to FIG. 8. The data may further be used in the transaction process 90 described with respect to FIG. 9 and the audit and compensation process 1000 described with respect to FIG. 10 below. Accordingly, the distributor database 40 preferably includes a distributor name field 42 for storing the name of the retailer, a distributor identifier field 44 for storing an identifier assigned to the distributor, a distributor address field 46 for storing the geographic location of the distributor, an employee identifier field 47 for storing the names of employees responsible for sales of the product at the distributor's location, a territory field 48 for storing a geographic area for which the distributor is responsible for sales, and a markup field 49 for storing a product markup value associated with each distributor.

The territory field 48 may describe a location for which the distributor is responsible for sales of one or more products offered through the seller's web site. The territory may be defined by one or more postal zip codes, telephone area codes, city, county or state names, or regional descriptions.

The markup field 49 is used to store the markup that a product is to receive over the seller's wholesale price, The markup value may be a multiplier that is to be applied to the wholesale price of each product. However, other forms of providing a markup value may be used with the present invention.

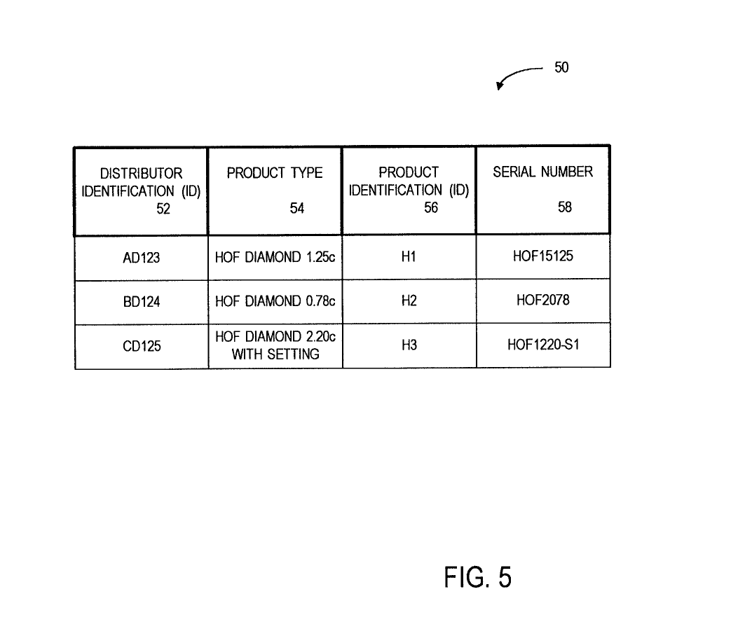

Turning now to FIG. 5, there is depicted an exemplary inventory database 50 through which local distributor may upload and maintain a list of their inventory of a seller's product. The inventory database 50 may be queried upon the request of a user to determine if a particular product is available at a distributor in the user's geographic location. The inventory database 50 may further be queried by the seller to confirm than minimum inventory amounts are being maintained by a local distributor. Accordingly, the inventory database 50 preferably includes a distributor identifier field 52 for storing an identification of a particular distributor, a product type field 54 for storing a product type corresponding to the product, a product identifier field 56 for storing an identification of a product for sale by the seller, and a serial number field 58 for storing a serial number or other verifiable product identifier of the product available for sale.

In a particular embodiment of the present invention, it is contemplated that the product to be sold may be a diamond and, perhaps, a setting for the same. In such case, the product type field 54 may include one or more of. a carat weight of the diamond, a cut of the diamond, a color of the diamond, a clarity of the diamond, a setting type for the diamond, and other relevant information. Other product types may be incorporated into the systems of the present invention, in which case, product type field 54 may include identifying information corresponding to other products than those shown. In addition, it is contemplated that where many similar or identical products are sold by a distributor, an inventory amount field (not shown) may be added to the inventory database 50.

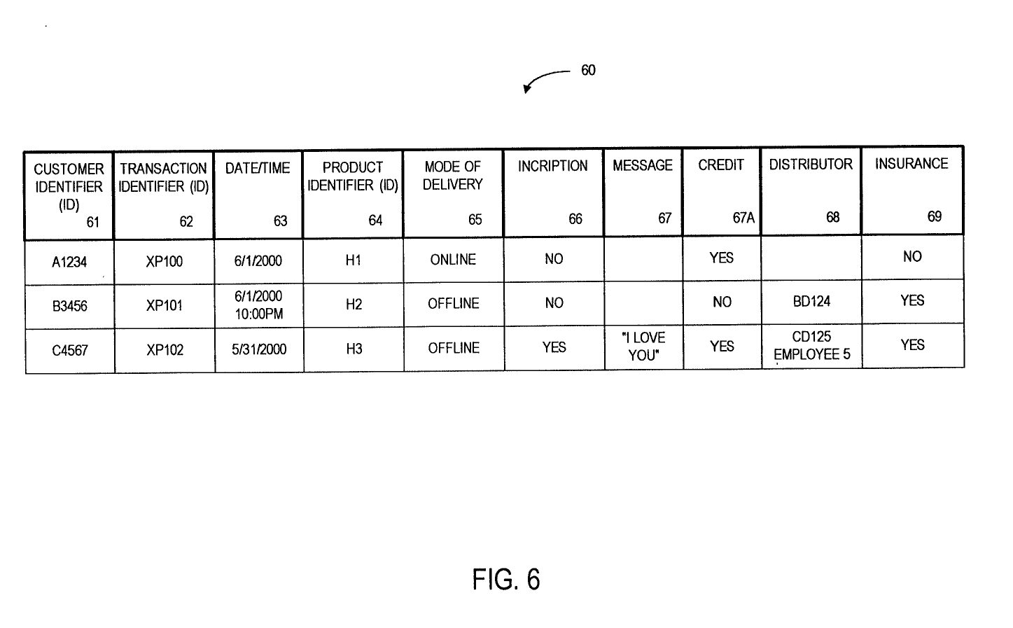

Turning now to FIG. 6, there is depicted a transaction database 60 in which product orders and the like are received stored by the central server 12. The data for the transaction database 60 is entered during the transaction process 80 described below with respect to FIG. 8. Data from the transaction database 60 is further used during the audit and compensation process 1000 described below with respect to FIG. 10. Accordingly, the transaction database 60 preferably includes a customer identifier field 61 for storing an identifier corresponding to a user ordering a product, a transaction identifier field 62 for storing a transaction identifier assigned to a product order from a user, a date/time field 63 for storing the date and time the product was ordered, a product identification field 64 for storing an identification of a product ordered by the user, a mode of delivery field 65 indicating whether the product is purchased for online or offline delivery, an inscription field 66 for storing an indication of whether product inscription was ordered for the product, a message field 67 for storing a message selected by a customer to be inscribed on the product, a credit field 67a for storing an indication of whether the transaction is an online credit transaction completed through the seller's web site, a distributor field 68 for storing an indication of the local distributor responsible for the sale which is preferably determined from the geographic location of the user, and an insurance field 69 indicating whether insurance was purchased for the product. Further fields may be provided in the transaction database 60 for storing a price of the product ordered and the like.

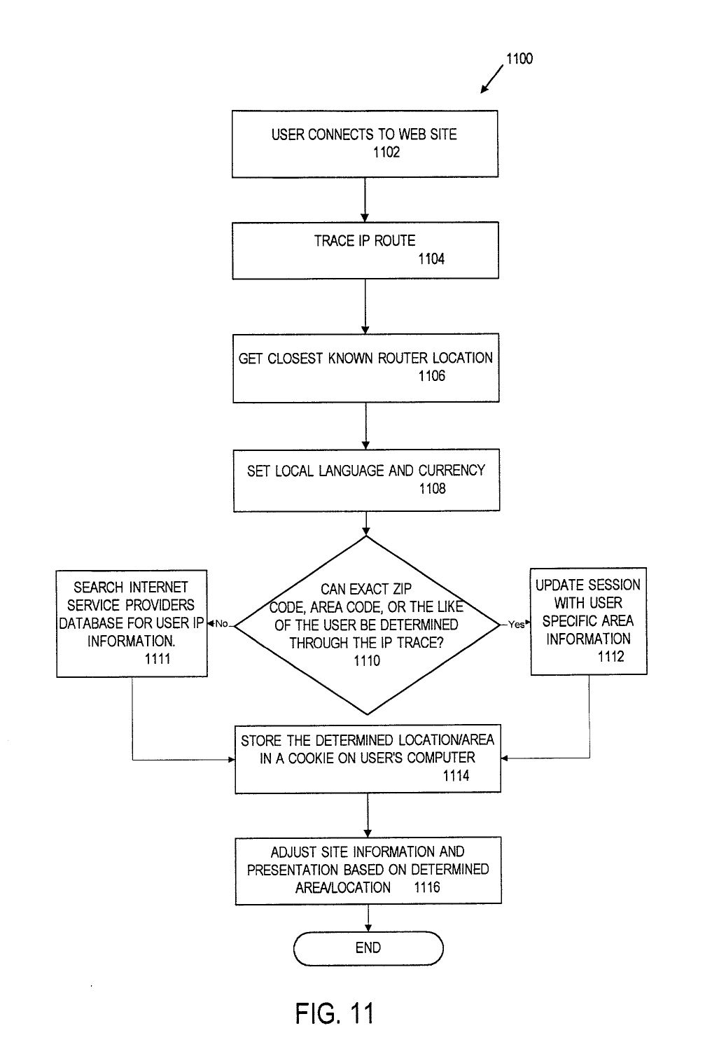

Referring now to FIG. 7, therein is depicted an exemplary user registration process 70 according to an embodiment of the present invention. Process 70 begins at step 71 where the user logs into a web site operated by the seller through seller sever 12. The user may access the web site by using a remote user terminal 16 in communication with the seller server 12 over the network connection 18. Next, at step 72, the user is queried to determine whether the user wishes to register with the operator of the web site. If not, the process 70 continues to steps 1104-1116, described below with respect to FIG. 11, in which the system may determine an approximate location for the user. If, however, the user wishes to register, the user is presented with a number of personal information fields to be completed (step 73). These fields correspond to the data stored in the user database of FIG. 3. Such information may include a user name, a user address including a zip code, a user telephone number including an area code, user demographic information (e.g., age, sex, occupation and income level of the user, and a financial account maintained by the user which is accessible for charging purchases.

A user identifier is next assigned to the user (step 74). The user identifier may be any alphabetic, numeric, or alphanumeric code which uniquely identifies the user, and may further include a user name and a password. The identifier may be selected by the user and confirmed as unique by the central server. In the alternative, the central server 12 may be programmed to generate a unique identifier for the user. This information is then stored in the user database 30 (step 75). The user may enter the identifier during subsequent visits to the central server 12 so that the user may be identified without having to re-enter such personal identification information. Upon entry of the data and assignment of the user identifier, the user registration process 70 ends.

Referring now to FIG. 8, an exemplary distributor registration process 80 is depicted. The registration process 80 begins upon the receipt and storage of distributor identification data entered by the distributor and received by the seller or operator of the web site (step 81). Such data may be entered online or provided offline to the seller or operator. The distributor identification data may include a distributor name, a distributor location, an identification of the region or regions in which the distributor is interested in selling the product, and an identification of employees of the distributor responsible for the sale of the product. Further information may be provided. Such distributor identification information is then preferably stored in the distributor database 40 of FIG. 4.

Next, at step 82, the distributor is given a territory in which they are responsible for sales of the product. The territory may be assigned to the distributor or retailer by the operator of the web site, and may be further based on the physical location of the distributor. Alternatively, one or more territories may be selected by the distributor. The distributor may pay a fee to the operator or seller for each territory selected, and may pay a further fee to make the territory exclusive to the distributor.

The distributor next provides inventory information corresponding to the number and types of product which the distributor has available for sale at the distributor's physical location (step 83). The inventory information may be updated in real time with each sale of a product by the distributor. Alternatively, the distributor may update the inventory information on a periodic basis. The distributor may also specify pricing for the product in his region (step 84). This information may then stored in the inventory database 50 of FIG. 5 (step 85). The distributor registration process 80 then ends.

Referring now to FIG. 9, there is depicted an exemplary transaction process 90 performed by the user in conjunction with the central server 12. The transaction process 90 begins when a user visits a web site operated by the central server 12. The user is first asked if the user is registered with the system (step 94). If the user indicates that she is registered, the user is prompted for the user identifier and/or a password which is confirmed by the seller server 12 through accessing the user database 30 of FIG. 3. If the user is not registered, the user is queried as to whether she wishes to register with the system (step 96). If the user so indicates, the user registration process 70 of FIG. 7 is initiated as described in the foregoing. If the user chooses not to register, the transaction process 90 to steps 1104-1116 of process 1100, described below with respect to FIG. 11, in which the system may determine at least an approximate location of the user. Alternatively, the location of the user may remain undetermined.

Next, whether or not the user has registered with the system, the user may then select product information which corresponds to product for sale by the seller via the web site (step 98). Such product information may include audio, visual and/or audio-visual messages and depictions describing the available products. In particular embodiments, the web site may offer an expert forum through which a user may submit questions regarding to the product to one or more experts, and receive answers from the same on a 24-hour basis.

The user may next query the system to determine the availability of a product in which the user is interested (step 100). The central server 12 then asks the user to submit the user's identifier assigned during the user registration process 70 of FIG. 7 (step 102). If the user is not registered, she is prompted to enter the registration process 70. If the user is registered, the process 90 continues below.

Next, the central server 12 determines an availability of the product requested (step 104). If the product is available, the user is queried to determine if the user wishes to purchase the product online or offline (step 106). If the online purchase is requested, the user is prompted to enter an address to which the product is to be shipped and the user provides a payment for the product (step 112). The online delivery may be completed by the operator of server 12 or by one of the local distributors. If an offline purchase is requested, the user's geographic location may be determined from the personal identification information received in the user registration process. The location information may be used to determine the local distributors which are in the user's geographic location, to present pricing data to the user in terms of the currency used at the user's geographic location, or to provide information in the official language in use at the user's geographic location. The user is then prompted to select a local distributor whom the user may visit to physically purchase the product (step 108). Alternatively, the system may automatically select the closest distributor, or the distributor having a territory corresponding to the user. The user may then authorize payment through the web site and elect to pick up the product at the distributor, in which case the distributor may receive 100% of the profits upon completion of the sale to the customer (step 110). Payment may be authorized in conjunction with the completion of a credit application as described in further detail below. In the alternative, the user may elect to provide payment information to the local distributor at the time she picks up the product. The purchase information received above is then stored in the transaction database 60 and the identified local distributor may be notified of the impending sale.

Whether online or offline purchase is requested, the user may then be queried to determine if she wishes the product to be inscribed with a personal message. If so, the user is prompted to enter or select a message to be inscribed on the product. In certain embodiments, it is contemplated that the product to be ordered is a diamond ring. The inscription may involve laser-inscribing a desired message onto the diamond through a process offered, for example, by HEARTS ON FIRE INC. of Boston, Mass. The laser inscription is preferably imbedded within the diamond and viewable through a 10× magnifier. Inscription on the band of the ring, or at any other desired location, may also be requested and provided.

Also, the central system 12 may query the user to determine if insurance for the product is requested (step 114). The insurance may include provisions which include compensation for the user in the event of loss, theft or damage of the product being sold. If the user elects to buy the insurance, such information is preferably stored in the transaction database 60.

After completion of the above-identified steps, the transaction process 90 ends.

It is further contemplated that individual sales of a product may occur strictly at a local distributor physical location, without interaction between the purchaser and the web site. Such traditional sales may be reported by the local distributor to the central server 12 at periodic intervals, and may be incorporated into the transaction database 60 for purposes of auditing and compensation as provided below.

Referring now to FIG. 10, an exemplary audit and compensation process 1000 is depicted. The audit and compensation process 1000 may be performed by the seller or may be performed by one of the local distributors using information for that distributor's geographic location only. As a first step in the process 1000) the central server 12 organizes the information in the transaction database 60 and determines sales figures for each local distributor and/or individual employee of the same for a given period of time (step 1002). The distributors and/or employees may then be ranked based on number of products sold, revenue generated from product sales, or the like (step 1004). Next, the central server 12 preferably compares the sales figures to pre-determined sales goals established by the seller (step 1006). The distributors and/or employees may then receive compensation based on the sales as compared to the goals (step 1008). The distributors may each access the sales figures for their assigned geographic regions to insure that the compensation is appropriate (step 1010) and may further update such sales figures on a periodic basis or in real time as each transaction occurs (step 1012), after which the audit and compensation process 1000 ends,

In one exemplary embodiment, each distributor may be ranked based on their sales figures. Those distributors within or above a certain percentile of total sales may then receive compensation from the seller. Such compensation may include preferred wholesale pricing for the product, an ownership interest in the seller's corporation, and/or an increase in the percentage of profits to be given to the distributor for each sale completed. Sales figures may be reviewed periodically and compensation may be revised based on changes in the distributor's sales figures.

In a second exemplary embodiment, individual employees of each distributor may be ranked based on the number of sales or revenue generated from their sales of the product. The individual employee may receive compensation from the seller, which may include a monetary commission, a discount on purchases of the product, a vacation package or the like.

Turning now to FIG. 11, therein is depicted an exemplary user location process 1100 by which the central server 12 may determine an approximate geographic location is of a user, when the user does not provide such information to the seller. The determined location information that results from process 1100 may be used, in conjunction with appropriate databases and programming steps, to provide the user with pricing for products in the user's region, to provide pricing data in the user's local currency, and/or to provide information in the official language for the user's location. Thus, the location process 1100 has important uses in certain international applications of the present invention.

The process 1100 begins at step 1102, wherein the user connects to the central server 12 over the network connection 18. The central server 12 then determines an internet protocol (IP) address assigned to the user's terminal 16 in any known manner, and traces all the network routers that provide the network connection (step 1104). The central server 12 then identifies an earliest router in a chain of routers that form the network connection 18 (step 1106).

In a particular embodiment, steps 1104 and 1106 may be accomplished by sending successive requests along the router path forming the network connection 18. The requests preferably contain a data packet that provides a limit on the number of times the message may be passed among routers in the network. Each time the message passes through a router, the limit is decremented by one. When the limit has been reached, an error message is returned to the central server 12 which includes the IP address of the last router encountered in the path. Using this method, a series of requests with increasing limits starting from a value of one can be transmitted along the network path. A plurality of error messages are returned as each request reaches its predetermined limit. As each request is returned, the IP addresses of successive routers in the path are identified. Eventually, a last of the transmitted requests may reach the user through the network path, and consequently, no error message will be returned. Using the request that was transmitted previous to this last request, an earliest network router in a chain of routers may be identified and its IP address provided. By accessing a database containing information about routers and their geographic locations, an approximate geographic location of the user can be identified and used. The database may be an existing database, such as those maintained by internet service providers and the like, or may be created specifically for purposes of conduct the location process 1100. If the router has an ordinary telephone number assigned to it, the approximate location of the router may be determined from its area code, which may, in turn, be determined from an automatic number identification (ANI) code transmitted by the router.

Returning to FIG. 11, the process 1100 continues to step 1108 wherein the web site displays currency and text language in use in the approximate geographic location of the router, as determined through the IP trace performed above. Next, at step 1110, the central server 12 determines whether an exact geographic location of the user has been determined from the IP trace. If not, the process continues to step 1111, wherein the central server 12 may access a database maintained, for example, by an Internet service provider of the user to determine the user's location. Such a database preferably includes records which can be used to cross-reference the user's IP address to the user's geographic location. If, on the other hand, an exact location of the user can be determined from the IP trace, the process 1100 continues to step 1112 wherein the specific location of the user is stored. Next, at step 1114 the central server 12 transmits, for example, a cookie containing the approximate or exact geographic location, as determined above, for storage on the user's terminal 16. In this manner, the tracing step above does not have to be repeated if the user leaves, and subsequently returns to the seller's web site, as is known in the art. The site content may then be updated to reflect the exact geographic location of the user (step 1116), if necessary. Process 1100 then ends.

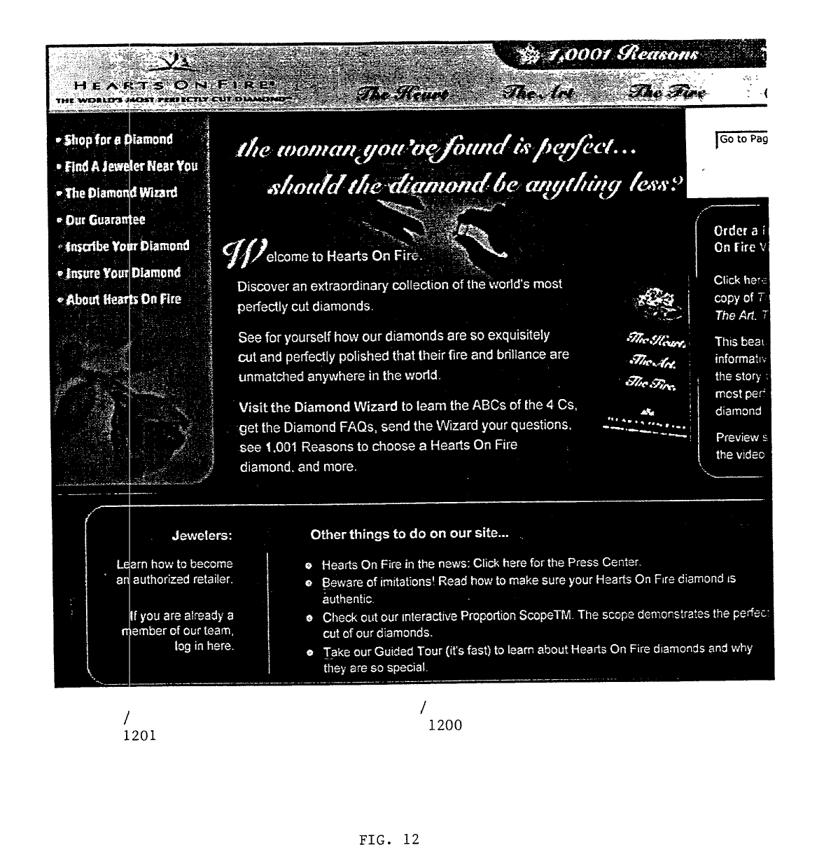

Turning to FIGS. 12-27, screen displays from an exemplary seller's web site are displayed. In FIG. 12, an exemplary seller's home page 1200 is displayed. This may be the first page a user sees when visiting the seller's web site, such as during step 71 of process 70, described above with respect to FIG. 7. The home page preferably contains information on products for sale, features available on the web site, and links 1201 to further web pages associated with the web site or features of the web site.

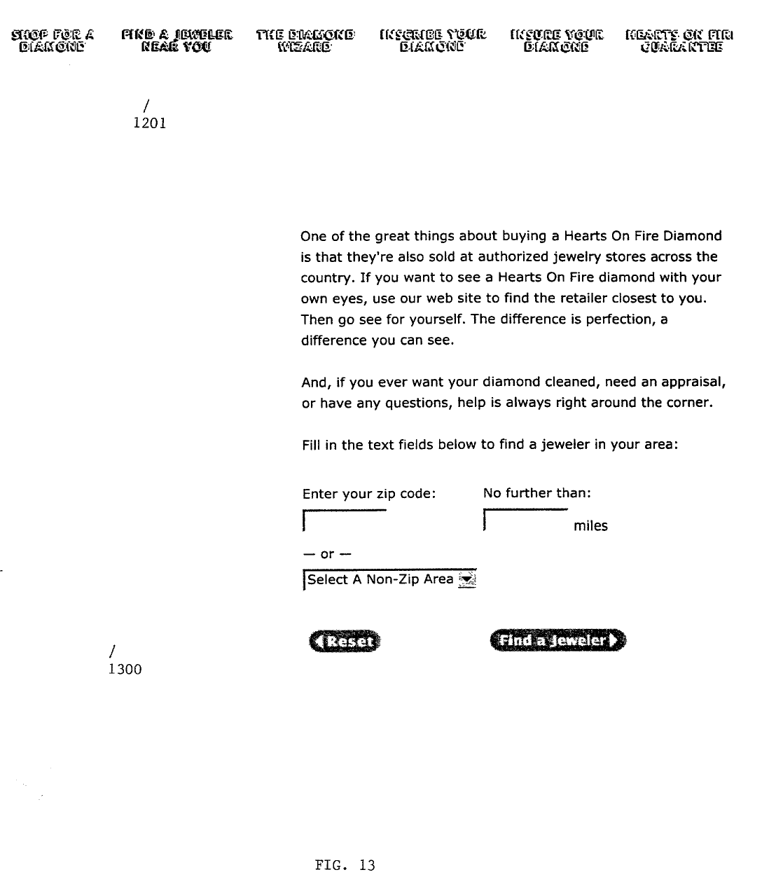

FIG. 13 depicts an exemplary screen display 1300 for receiving an input of user identification data, such as the user's zip code or other identification information. This screen display 1300 may be displayed, for example, during step 73 of process 70, described above with respect to FIG. 7.

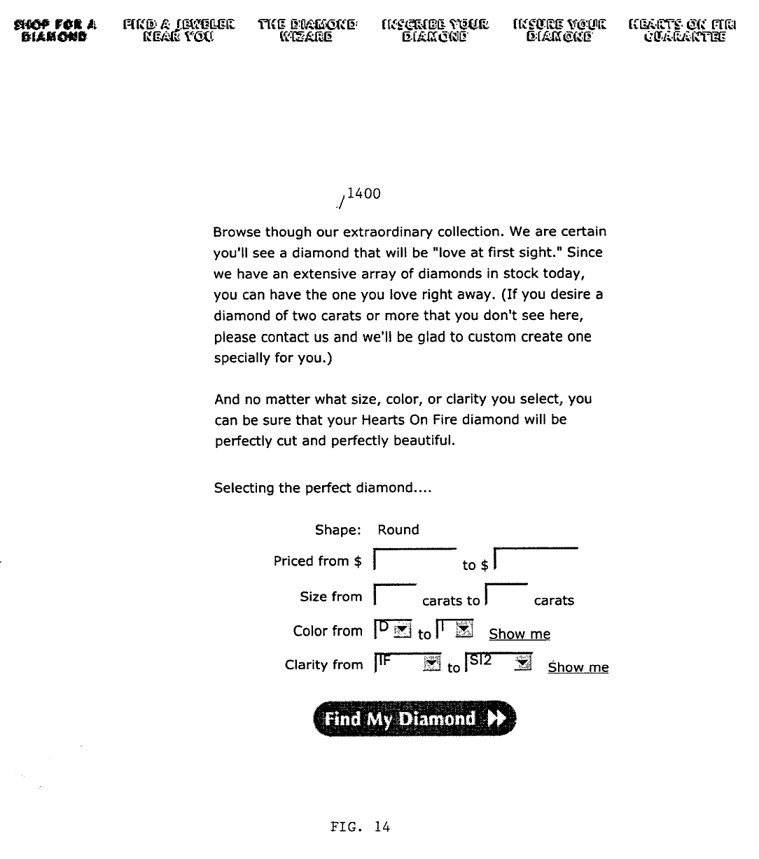

FIG. 14 presents an exemplary screen display 1400 by which a user may enter product criteria for a product in which the user is interested in purchasing.

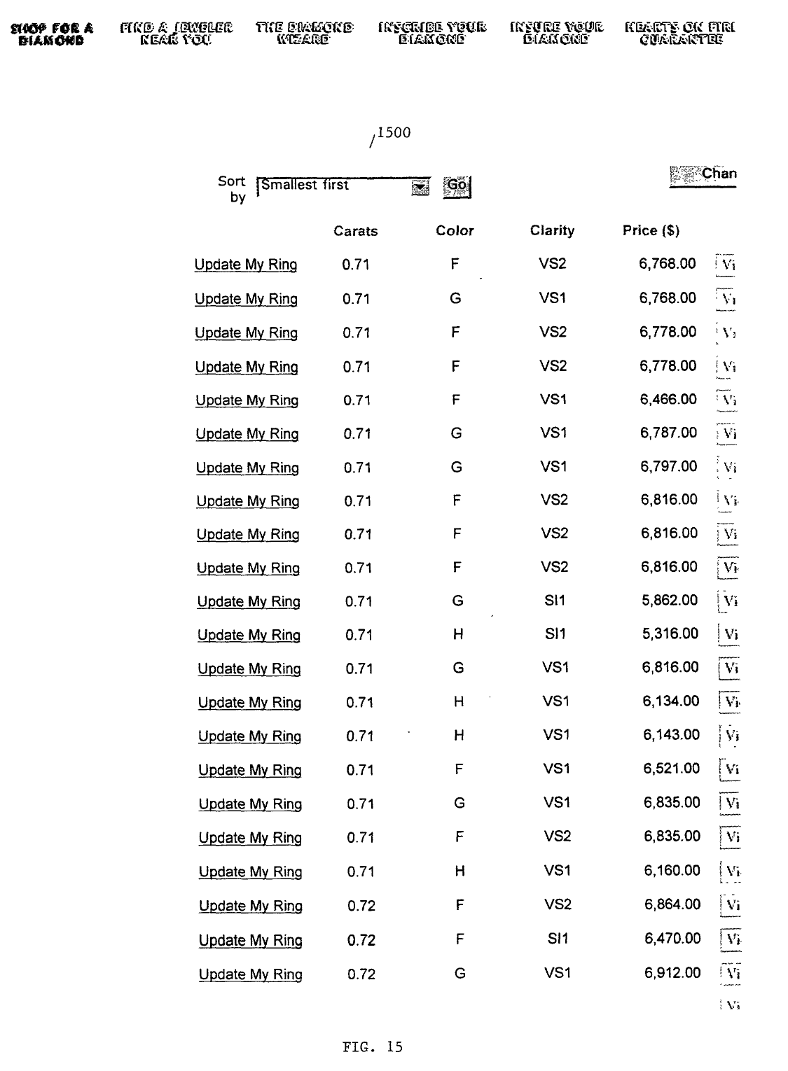

FIG. 15 displays exemplary search results 1500 for products matching the criteria that may be entered by the user through screen display 1400 above. These screen displays 1400, 1500 may be presented to the user, for example, during step 98 of process 90, discussed above with respect to FIG. 9.

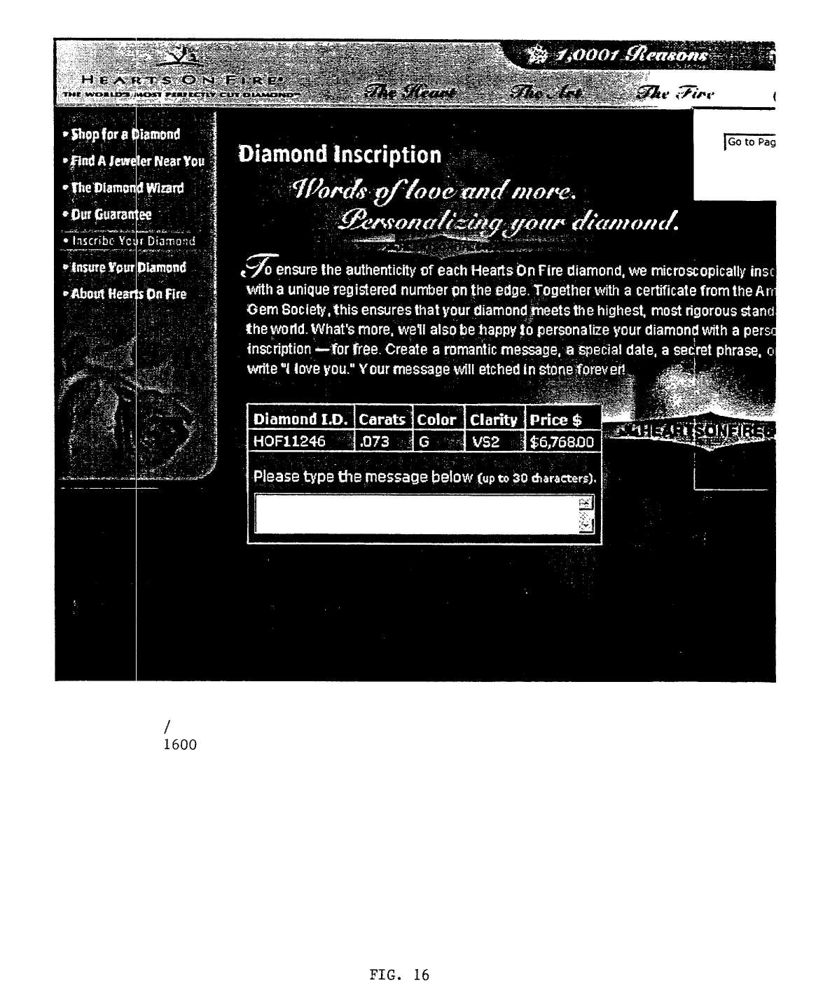

FIG. 16 presents an exemplary screen display 1600 through which a user may enter a message to be inscribed on the product. In preferred embodiments, the product is a diamond which may be laser-inscripted with the message in any known manner. Screen display 1600 may be presented to the user during, for example, step 114 of process 90, described above with respect to FIG. 9.

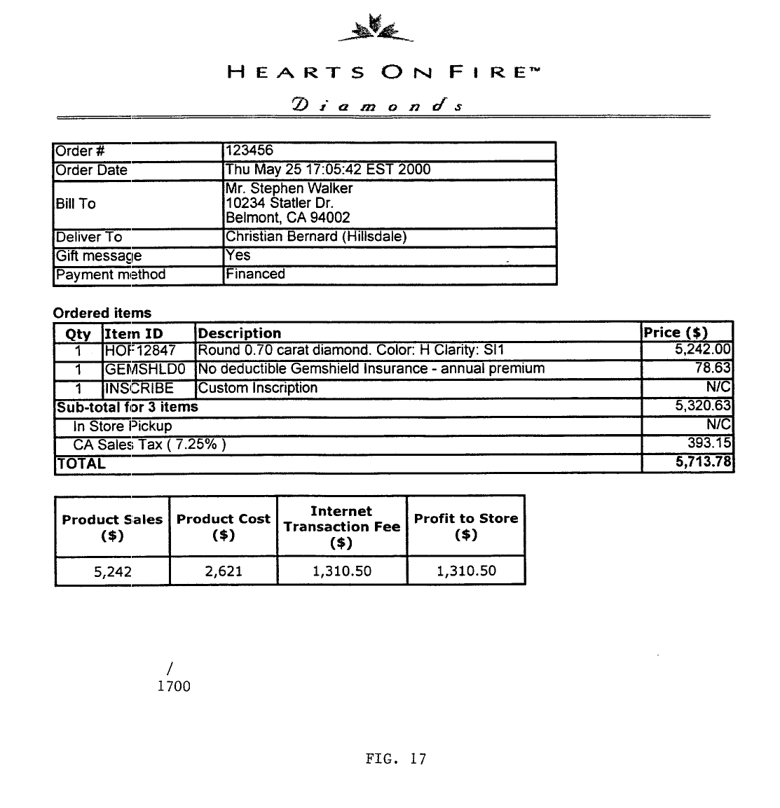

FIG. 17 present an exemplary screen display 1700 of a product order completed by a user in purchasing a product through the seller's web site. Profit information and the like may be hidden from the user, but may be provided to the distributor during the audit and compensation process 1000, described above with respect to FIG. 10.

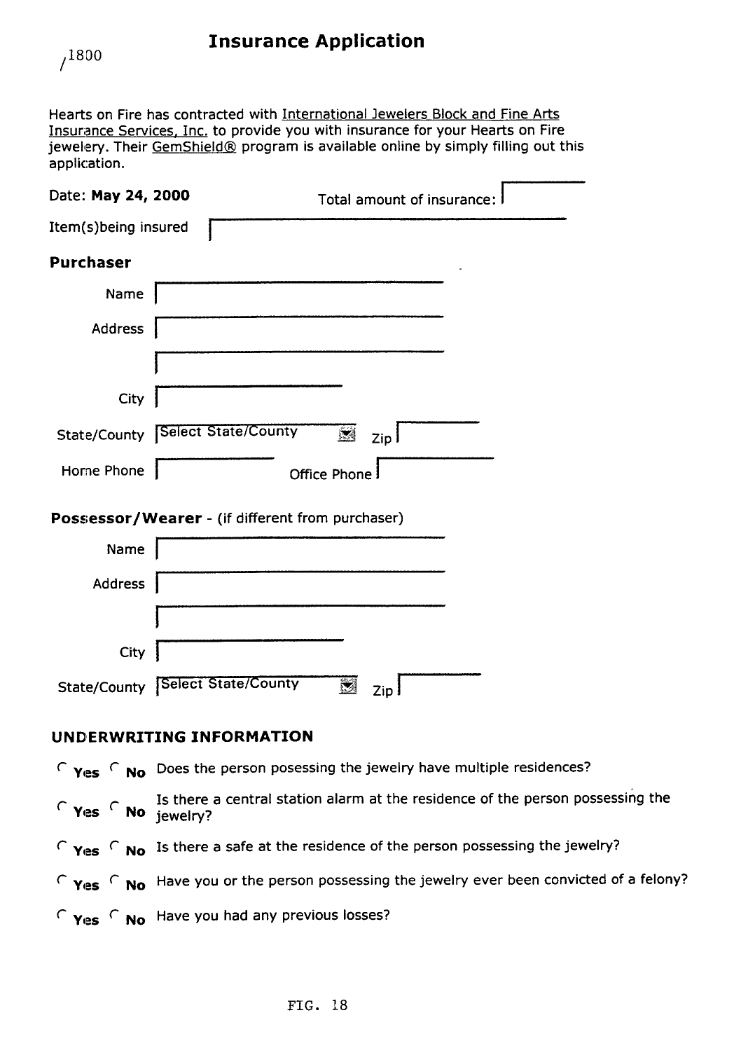

FIGS. 18-21 present an exemplary screen display 1800 through which a user may elect to purchase insurance for the product. The insurance may be provided by the operator of the web site (e.g. the seller of the product) or by a third party insurer.

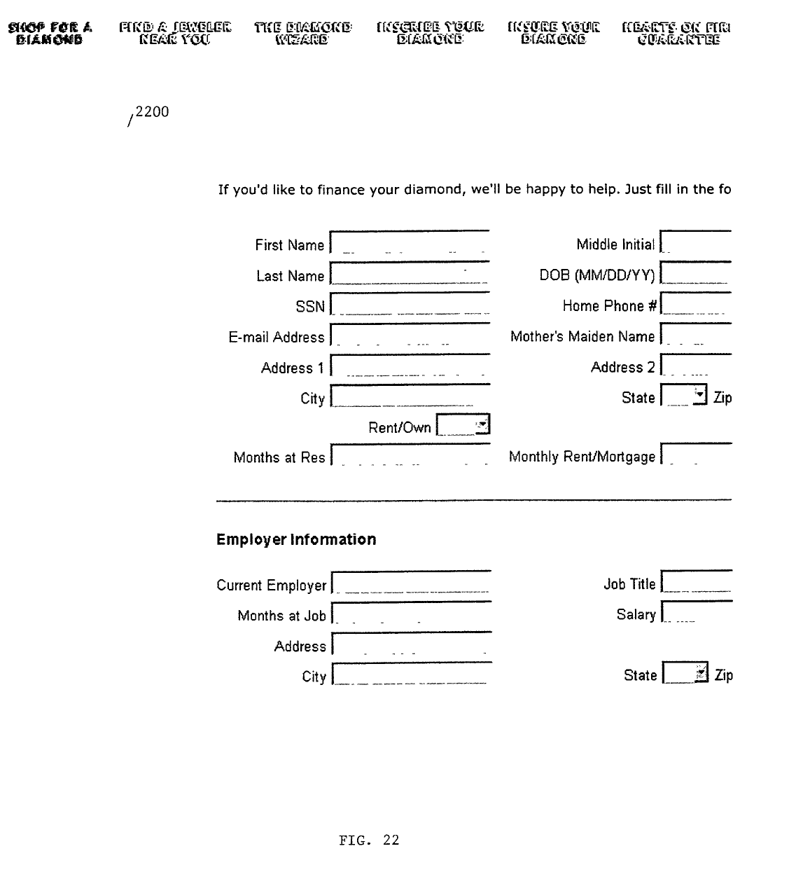

FIG. 22 presents an exemplary screen display 2200 by which a user may apply for financing in order to complete a purchase of a product. The financing may be provided by the seller, or through a third party credit provider. The financing may further be provided only when the user meets predetermined credit criteria, as is usually determined from a user's credit history, or in any other manner known in the art.

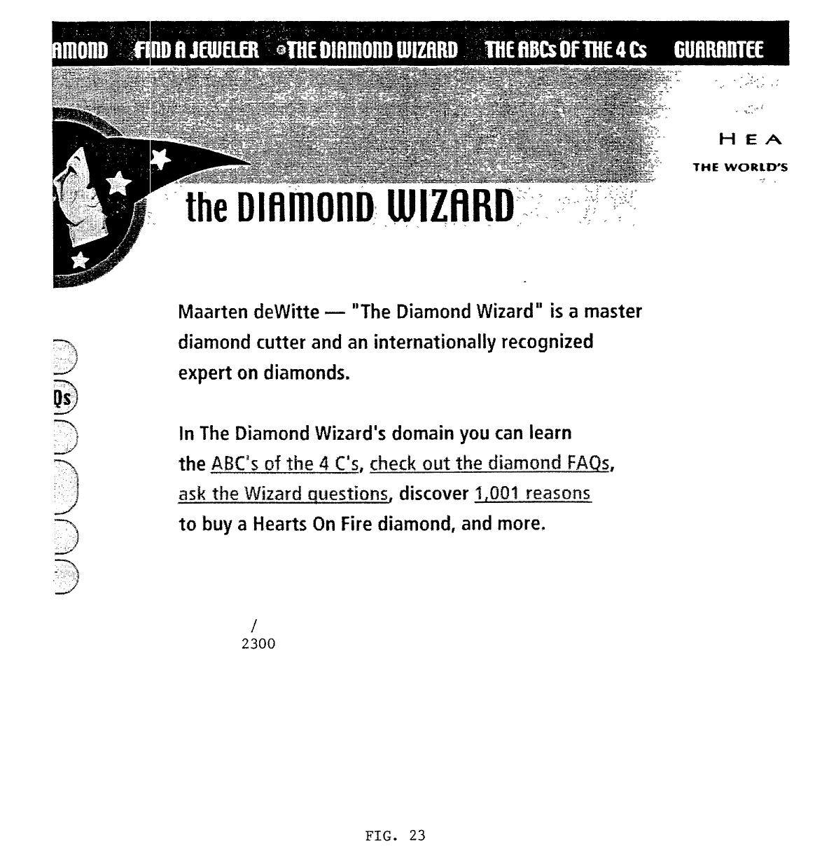

FIG. 23 presents an exemplary screen display 2300 by which a user may select product information to view or submit a question regarding a product to an expert. Screen display 2300 may be presented, for example, when a user selects a link to submit a question to an expert, such as through one of the links 1201 of screen display 1200, described above with respect to FIG. 12.

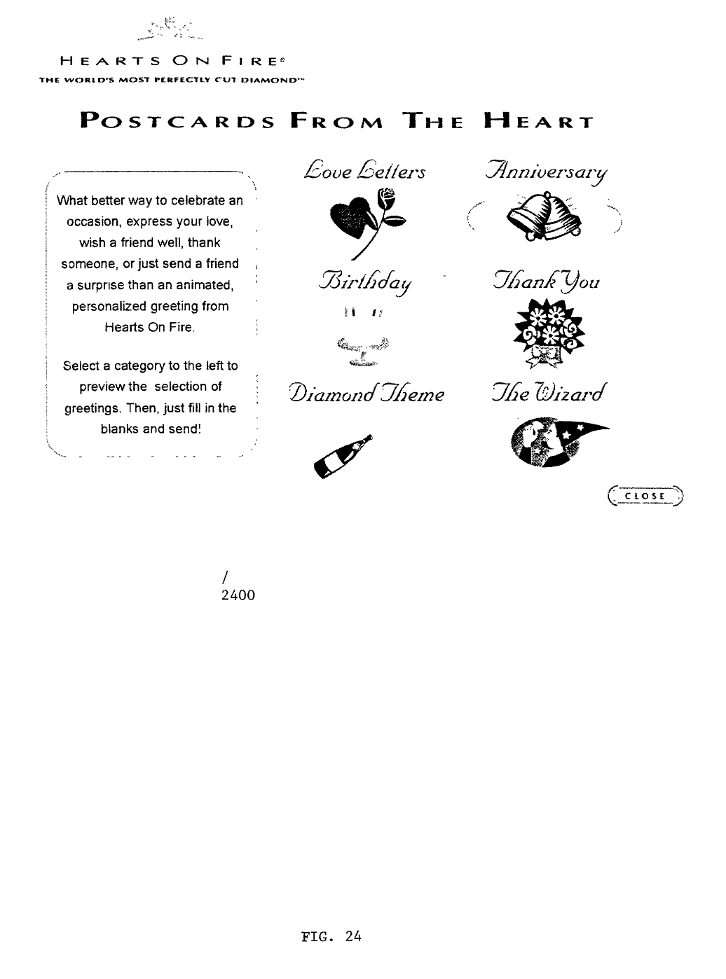

FIG. 24 presents an exemplary screen display 24 by which a user may select an online greeting to transmit to a third party. Screen display 2300 may be presented, for example, when a user selects a link to select an online greeting, such as through one of the links 1201 of screen display 1200, described above with respect to FIG. 12. Online greeting may include delivery of text and graphics to a specified e-mail address corresponding to an acquaintance of the user, but may be accomplished in any manner known in the art.

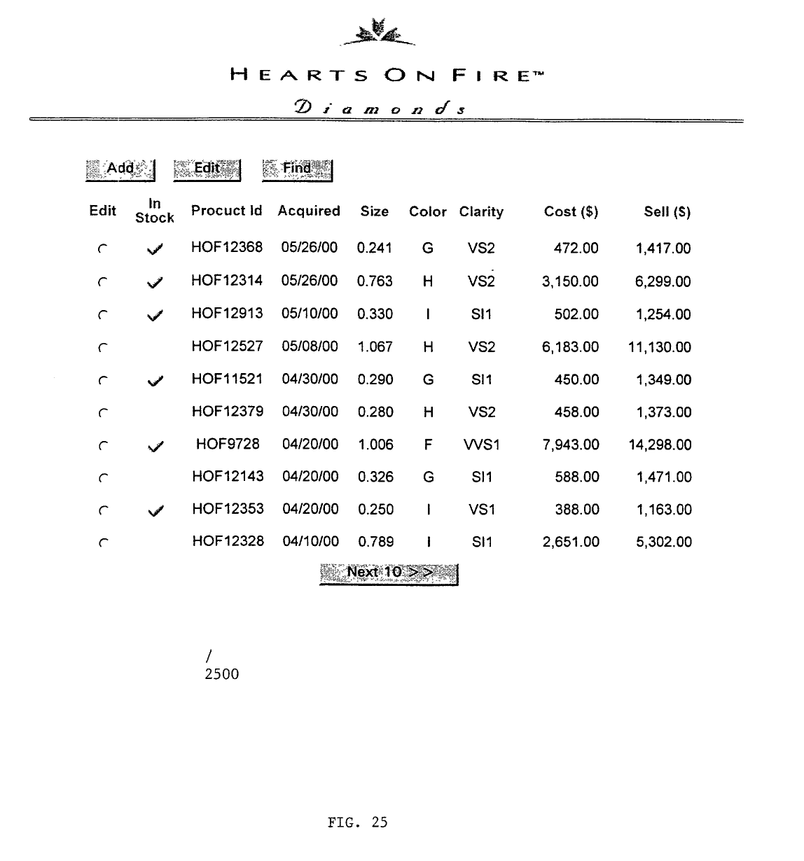

FIGS. 25-27 relate to retailer interaction with the seller web site. FIG. 25. Depicts exemplary inventory data 2500 provided by a retailer. The inventory data may correspond to the data stored in inventory database 50, described above.

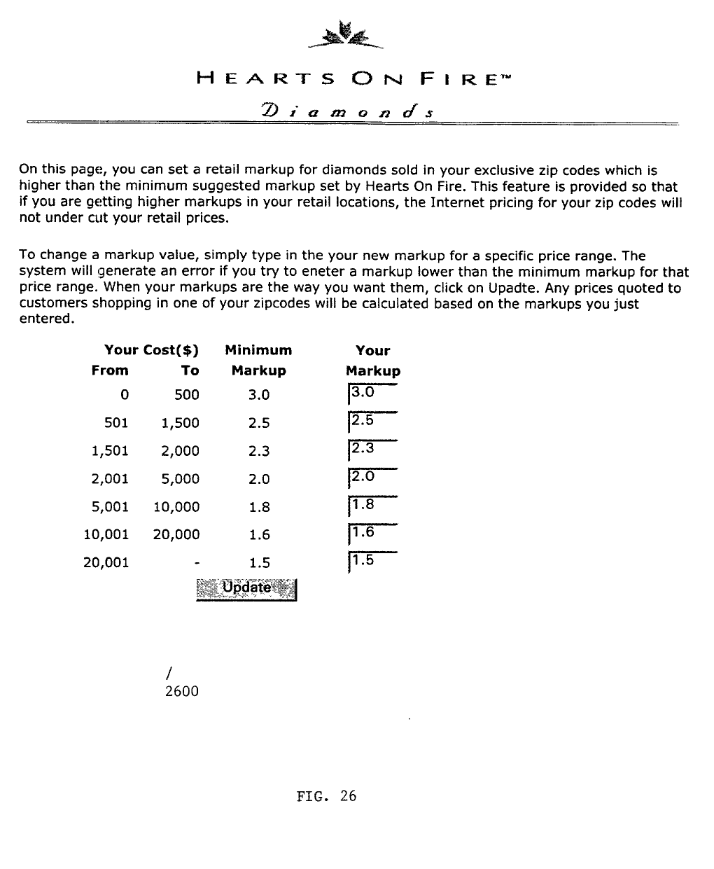

FIG. 26 depicts an exemplary screen display 2600 by which a retailer may select a pricing structure for products available for sale. The pricing structure may be based on a markup multiplier to be applied to the wholesale price of the product. Other methods for selecting pricing for products may likewise be used.

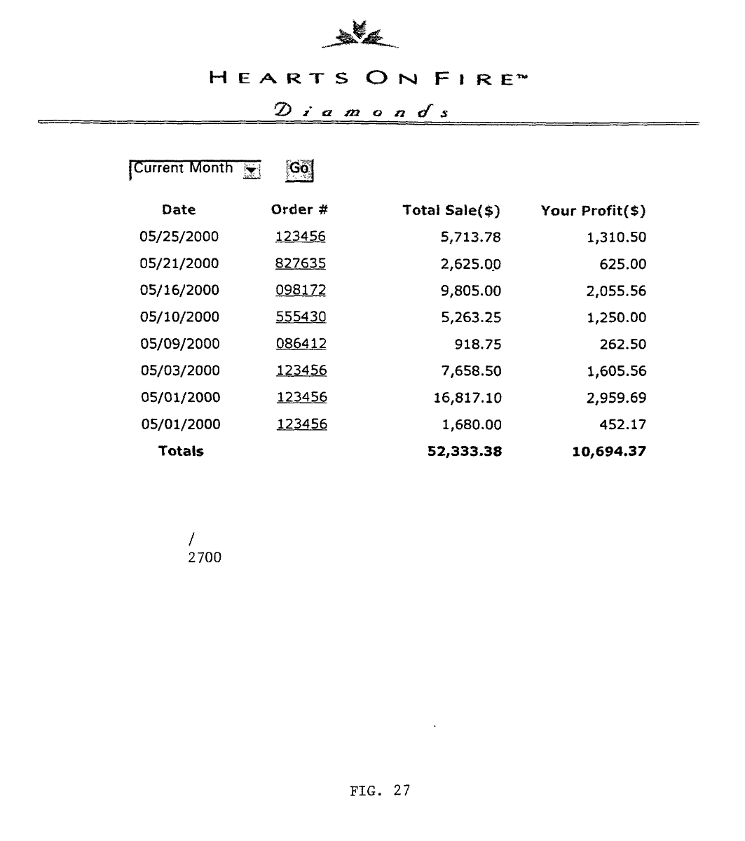

Finally, FIG. 27 presents an exemplary screen display 2700 of an audit performed by the retailer for online and offline sales, as described previously above. Preferably, the retailer is able to view all transactions within the retailer's geographic location during a predetermined time (i.e. the previous month). Other relevant data may likewise be provided.

In further embodiments of the present invention, it is contemplated that a product purchased by the user may be returned to a local distributor. If the product was purchased through the distributor, the seller may not compensate the distributor for the return. However, if the product was purchased online or through another distributor, the seller may compensate the distributor who received the product. The returned product may then be added to the distributors inventory or provided to the seller for sale online.

In an additional embodiment of the present invention, it is contemplated that a user may be directed to the seller's web site from other affiliated or unaffiliated web sites. This may be accomplished by placing banner advertisements on third party web sites, which direct the user to the seller's web site upon selection by the user, as is well known in the rt. The operator of the web site may receive further revenues by placing third party banner advertisements on the sellers web site.

Although the invention has been described in detail in the foregoing embodiments, it is to be understood that the descriptions have been provided for purposes of illustration only and that other variations (i.e., the performance of process step in a different order than described) can be made thereupon by those skilled in the art without departing from the spirit and scope of the invention, which is defined solely by the appended claims.

What is claimed is:

1. A method for selling a product online, comprising:
registering a plurality of retailers;
receiving a product order from a user;
determining a geographic location of the user; and
transmitting the product order to one of the plurality of retailers, based on the geographic location of the user.

2. The method of claim 1, wherein the product corresponds to a purchase of a diamond.

3. The method of claim 1, wherein said registering is performed online.

4. The method of claim 1, wherein said registering further comprises:
receiving, from a retailer, a selection of a territory corresponding to a geographic location for which the retailer is identified.

5. The method of claim 4, wherein the territory is an exclusive territory.

6. The method of claim 4, further comprising:
receiving a payment from the retailer for the selection.

7. The method of claim 1, wherein said registering further comprises:
receiving a retailer geographic location corresponding to a physical location of each retailer;
assigning a territory to each retailer based on the physical location.

8. The method of claim 1, wherein said registering further comprises:
receiving from each retailer at least one of: a retailer name, a retailer location, an employee name corresponding to an employee of the retailer, and an inventory of products available from the retailer.

9. The method of claim 1, wherein said registering further comprises:
receiving from each retailer a markup amount for a product available from the retailer.

10. The method of claim 1, wherein said receiving further comprises:
receiving a description of a desired product;
searching an inventory of available products;
providing a list of at least one available product corresponding to the description; and
receiving a selection of an available product from the user.

11. The method of claim 10, wherein said providing further comprises:
providing a list of at least one retailer having the available product.

12. The method of claim 11, further comprising:
providing a price for which at least one retailer will sell the available product.

13. The method of claim 10, further comprising:
receiving a second selection of a delivery preference from the user.

14. The method of claim 13, wherein the delivery preference comprises one of:
a shipment of the available product to the user or a pick-up of the available product from the retailer.

15. The method of claim 1, wherein said determining comprises:
receiving a description of the user's geographic location from the user.

16. The method of claim 15, wherein the description comprises at least one of: a zip code corresponding to the user, a city corresponding to the user and a telephone area code corresponding to the user.

17. The method of claim 1, wherein said determining further comprises:
determining an earliest network router from which the user is connected; and
determining the geographic location based on the location of the earliest network router.

18. The method of claim 1, wherein said determining further comprises:
determining an internet protocol address of a computer used by the user;
accessing an internet provider database storing the internet protocol address; and
retrieving a geographic location of internet protocol address from the internet provider database.

19. The method of claim 1, further comprising:
receiving a payment from the user for the product order.

20. The method of claim 19, further comprising:
providing at least a portion of the payment to the retailer.

21. The method of 19, further comprising:
providing a commission to an employee of the retailer.

22. The method of claim 1, wherein the product order further comprises at least one of:
a product size, a product color, a product clarity, a product cut, a price of a product, a delivery preference for the product, an insurance amount for the product, and an inscription for the product.

23. The method of claim 1, further comprising:
receiving a request for financing the product order.

24. The method of claim 1, further comprising:
providing product information corresponding to the product order to the user.

25. The method of claim 1, further comprising:
providing a forum through which the user may submit a question regarding the product.

26. The method of claim 1, further comprising:
registering at least one user.

27. The method of claim 1, further comprising:
receiving a product description of a desired product from the user; and
presenting a list of available products corresponding to the desired product, wherein a first of the available products corresponds to a retailer having a location closest to the geographical location of the user.

28. A computer-readable medium encoded with processing instructions for implementing a method for selling a product online, the method comprising:
registering a plurality of retailers;
receiving a product order from a user;
determining a geographic location of the user; and
transmitting the product order to one of the plurality of retailers, based on the geographic location of the user.

29. An apparatus for selling a product online, comprising:
means for registering a plurality of retailers;
means for receiving a product order from a user;
means for determining a geographic location of the user; and
means for transmitting the product order to one of the plurality of retailers, based on the geographic location of the user.

30. An apparatus for selling a product online, comprising:
a processor; and
a memory in operative communication with the processor, the memory for storing processing instructions directing the processor to:
register a plurality of retailers;
receive a product order from a user;
determine a geographic location of the user; and
transmit the product order to one of the plurality of retailers, based on the geographic location of the user.

31. A method for identifying a geographic location of a user accessing a web site by a computer over a network, comprising:
determining an internet protocol address of a user's computer;
accessing an internet provider database storing the internet protocol address; and
retrieving a geographic location of the user from the internet provider database.

32. The method of claim 31, further comprising:
receiving a product order from the user; and
selecting a retailer to fulfill the product order based on the geographic location of the user.

33. A computer-readable medium encoding with processing instructions for implementing a method, performed by a computer, for identifying a geographic location of a user accessing a web site by a computer over a network, the method comprising:
determining an internet protocol address of a user's computer;
accessing an internet provider database storing the internet protocol address; and
retrieving a geographic location of the user from the internet provider database.

34. An apparatus for identifying a geographic location of a user accessing a web site by a computer over a network, comprising:
means for determining an internet protocol address of a user's computer;
means for accessing an internet provider database storing the internet protocol address; and
means for retrieving a geographic location of the user from the internet provider database.

35. An apparatus for identifying a geographic location of a user accessing a web site by a computer over a network, comprising:
a processor; and
a memory in operative communication with the processor, the memory for storing a plurality of processing instructions for directing the processor to:
determine an internet protocol address of a user's computer,
access an internet provider database storing the internet protocol address; and
retrieve a geographic location of the user from the internet provider database.

36. A method for identifying a geographic location of a user accessing a web site by a computer over a network, comprising:
identifying an earliest network router from which the user is connected to the network;
determining a location of the earliest network router based on an ANI address; and
determining the geographic location of the user based on the location of the earliest network router.

37. The method of claim 36, wherein said determining the location of the earliest network router comprises:
accessing a database storing a plurality of telephone area codes and a plurality of corresponding geographic locations for the telephone area codes;
retrieving an area code from the ANI of the earliest network router; and
comparing the retrieved area code to the plurality of telephone area codes and corresponding geographic locations to determine the geographic location of the earliest network router.

38. The method of claim 36, further comprising:
receiving a product order from the user; and
selecting a retailer to fulfill the product order based on the geographic location of the user.

39. A computer-readable medium encoded with processing instructions for implementing a method, performed by a computer, for identifying a geographic location of a user accessing a web site by a computer over a network, the method comprising:
identifying an earliest network router from which the user is connected to the network;
determining a location of the earliest network router based on an ANI address; and
determining the geographic location of the user based on the location of the earliest network router.

40. An apparatus for identifying a geographic location of a user accessing a web site by a computer over a network, comprising:
means for identifying an earliest network router from which the user is connected to the network;
means for determining a location of the earliest network router based on an ANI address; and
means for determining the geographic location of the user based on the location of the earliest network router.

41. An apparatus for identifying a geographic location of a user accessing a web site by a computer over a network, comprising:
a processor; and
a memory in operative communication with the processor, the memory for storing a plurality of processing instructions for directing the processor to:
identify an earliest network router from which the user is connected to the network;
determine a location of the earliest network router based on an ANI address corresponding to the router; and
determine the geographic location of the user based on the location of the earliest network router.

42. A method for registering a retailer to accomplish an online sale of a product, comprising:
receiving, from a retailer, a selection of a territory corresponding to a geographic location for which the retailer is responsible for a product sale;
receiving, from the retailer, an inventory of available products;
receiving, from the retailer, a price at which at least one of the available products is to be sold.

43. The method of claim 42, wherein the territory is an exclusive territory.

44. The method of claim 42, further comprising:
receiving a payment from the retailer for the selection.

45. The method of claim 42, wherein said receiving a selection comprises:
receiving an indication of a physical location of the retailer; and
assigning a territory to the retailer based on the physical location.

46. The method of claim 42, further comprising:
receiving from the retailer at least one of: a retailer name, a retailer location, and an employee name corresponding to an employee of the retailer.

47. The method of claim 42, wherein said receiving a price further comprises:
receiving, from the retailer, a markup amount for at least one product available from the retailer.

48. The method of claim 42, further comprising:
receiving a product order for a product having a purchase price from a user in the territory assigned to the retailer;
receiving a confirmation of a delivery of the product by the retailer; and
providing at least a portion of the purchase price to the retailer.

49. The method of claim 48, wherein said providing further comprises:
providing a commission to at least one of: the retailer and an employee of the retailer.

50. The method of claim 42, further comprising:
storing an indication of a sale of the product in a transaction database accessible by the retailer.

51. A method for registering with a seller to accomplish an online sale of a product, comprising:
transmitting, to the seller, a selection of a territory corresponding to a geographic location for which a retailer is responsible for a product sale;
transmitting, to the seller, an inventory of available products; and
transmitting, to the seller, a price at which at least one of the available products is to be sold.

52. The method of claim 51, wherein the territory is an exclusive territory.

53. The method of claim 51, further comprising:
transmitting a payment to the seller for the selection.

54. The method of claim 51, wherein said transmitting a selection comprises:
transmitting an indication of a physical location of the retailer; and
receiving at least one assigned territory based on the physical location.

55. The method of claim 51, further comprising:
transmitting, to the seller, at least one of: a retailer name, a retailer location, and an employee name corresponding to an employee of the retailer.

56. The method of claim 51, wherein said transmitting a price further comprises:
transmitting, to the seller, a markup amount for at least one product available from the retailer.

57. The method of claim 51, further comprising:
receiving a product order for a product having a purchase price from a user in the territory assigned to the retailer;
delivering the product to the user;
transmitting a confirmation of a delivery of the product by the retailer; and
receiving at least a portion of the purchase price from the seller.

58. The method of claim 57, wherein said providing further comprises:
receiving a commission from the seller for the product order.

59. The method of claim 51, further comprising:
auditing a transaction database maintained by the seller.

60. A method for purchasing a product, comprising:
connecting to seller web site;
providing an identification of a geographic location;
ordering a product from the seller web site; and
receiving the product from a local retailer corresponding to the geographic location.
